(19) United States
(12) Patent Application Publication
(10) Pub. No.: US 2024/0136113 A1
(43) Pub. Date: Apr. 25, 2024

(54) COIL COMPONENT

(71) Applicant: SAMSUNG ELECTRO-MECHANICS CO., LTD., Suwon-si (KR)

(72) Inventors: Byeong Cheol MOON, Suwon-si (KR); In Young KANG, Suwon-si (KR); Seok Hwan AHN, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/369,376

(22) Filed: Sep. 17, 2023

(30) Foreign Application Priority Data
Oct. 20, 2022 (KR) 10-2022-0136493

(51) Int. Cl. H01F 27/29; H01F 27/255

(52) U.S. Cl. CPC H01F 27/292; H01F 27/255

(57) ABSTRACT

A coil component includes: a body having first and second recesses on outer surfaces, and including magnetic powder particles; a support member disposed in the body; a coil disposed on the support member; and first and second external electrodes disposed on one surface of the body and respectively extending to the first and second recesses to be connected to the coil, wherein the body is divided into a first region and a second region, an average diameter of the magnetic powder particles included in the second region is smaller than an average diameter of the magnetic powder particles included in the first region, and the first and second recesses are disposed in the second region.

### CROSS-REFERENCE TO RELATED APPLICATION(S)

This application claims benefit of priority to Korean Patent Application No. 10-2022-0136493 filed on Oct. 21, 2022 in the Korean Intellectual Property Office, the disclosure of which is incorporated herein by reference in its entirety.

### BACKGROUND

### 1. Technical Field

The present disclosure relates to a coil component.

### 2. Description of Related Art

An inductor, a coil component, is a representative passive electronic component used in an electronic device, together with a resistor and a capacitor.

As the electronic devices gradually become more sophisticated and miniaturized, the number of electronic components used in the electronic device is also increased and sizes thereof are miniaturized.

Meanwhile, there is demand for a coil component with a lower surface electrode structure in which an external electrode is exposed only to a mounting surface to require a smaller mounting area and have a lower risk of a short circuit occurring between the external electrode and a component adjacent thereto, which is advantageous for integration when the coil component is mounted on a printed circuit board (PCB).

### SUMMARY

An aspect of the present disclosure may provide a coil component with improved plating quality by partially applying a fine powder sheet to a region in which external electrodes are to be disposed when forming a body thereof, including a magnetic sheet to reduce surface-roughness of the region.

Another aspect of the present disclosure may provide a coil component with an improved insulation printing quality by partially applying a fine powder sheet to a region in which a lower insulating layer is to be disposed when forming its body including a magnetic sheet to reduce surface-roughness of the region.

Another aspect of the present disclosure may provide a coil component with minimum permeability degradation caused by application of a fine powder sheet by using a coarse powder sheet in a region having a lower need for lower surface-roughness.

According to an aspect of the present disclosure, a coil component may include: a body having first and second recesses formed in an outer surface, and including magnetic powder particles; a support member disposed in the body; a coil disposed on the support member; and first and second external electrodes disposed on one surface of the body and respectively extending to the first and second recesses to be connected to the coil, wherein the body is divided into a first region and a second region, an average diameter of the magnetic powder particles included in the second region is smaller than an average diameter of the magnetic powder particles included in the first region, and the first and second recesses are formed in the second region.

According to an aspect of the present disclosure, a coil component may include: a body having first and second recesses formed in an outer surface, and including magnetic powder particles; a support member disposed in the body; a coil disposed on the support member; and first and second external electrodes disposed on one surface of the body and respectively extending to the first and second recesses to be connected to the coil, wherein the body is divided into a first region and a second region, a thickness of the second region is greater in a middle portion of the body than in a region between the coil and the one surface of the body, and the first and second recesses are formed in the second region.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view schematically illustrating a coil component according to a first exemplary embodiment of the present disclosure;

FIG. 2 is a view illustrating a cross-section taken along line I-I′ in FIG. 1;

FIG. 3 shows enlarged views of regions A1 and A2;

FIG. 4 shows enlarged views of regions B1 and B2;

FIG. 5 is a view illustrating a cross-section taken along line II-II′ in FIG. 1;

FIG. 6 is a view briefly showing a manufacturing process of the coil component according to a first exemplary embodiment of the present disclosure;

FIG. 7 is a perspective view schematically illustrating a coil component according to a second exemplary embodiment of the present disclosure;

FIG. 8 is a view illustrating a cross-section taken along line III-III′ in FIG. 7, and is a view corresponding to FIG. 2;

FIG. 9 is a view illustrating a cross-section taken along line IV-IV′ in FIG. 7, and is a view corresponding to FIG. 5;

FIG. 10 is a perspective view schematically illustrating a coil component according to a third exemplary embodiment of the present disclosure;

FIG. 11 is a view illustrating a cross-section taken along line V-V′ in FIG. 10, and is a view corresponding to FIG. 2;

FIG. 12 is a view briefly showing a manufacturing process of the coil component according to a third exemplary embodiment of the present disclosure; and

FIG. 13 is a view illustrating that the coil component according to a first exemplary embodiment of the present disclosure is mounted on a printed circuit board (PCB).

### DETAILED DESCRIPTION

Hereinafter, exemplary embodiments of the present disclosure will now be described in detail with reference to the accompanying drawings.

In the drawings, an L direction refers to a first direction or length direction, a W direction refers to a second direction or width direction, and a T direction refers to a third direction or thickness direction.

Hereinafter, a coil component according to exemplary embodiments of the present disclosure will be described in detail with reference to the accompanying drawings. In describing the exemplary embodiments of the present disclosure with reference to the accompanying drawings, components that are the same as or correspond to each other will be denoted by the same reference numerals, and an overlapping description thereof will be omitted.

Various kinds of electronic components may be used in an electronic device, and various kinds of coil components may be appropriately used between these electronic components depending on their purposes in order to remove noise or the like.

That is, the coil component used in the electronic device may be a power inductor, high frequency (HF) inductor, a general bead, a bead for a high frequency (GHz), a common mode filter, or the like.

### First Exemplary Embodiment

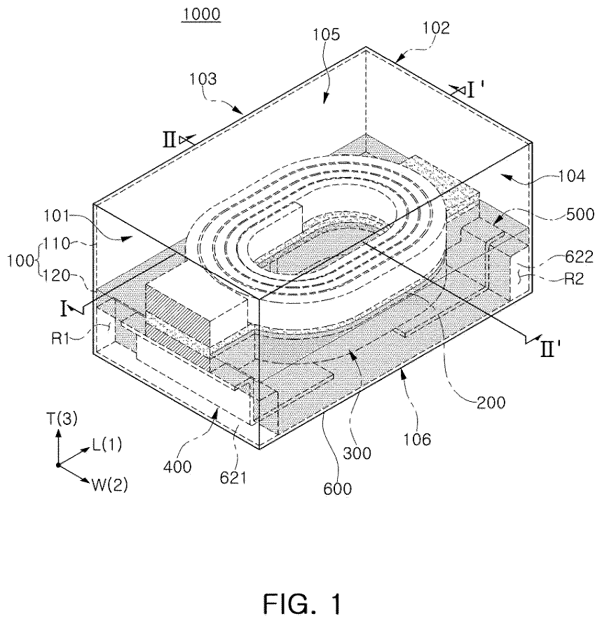

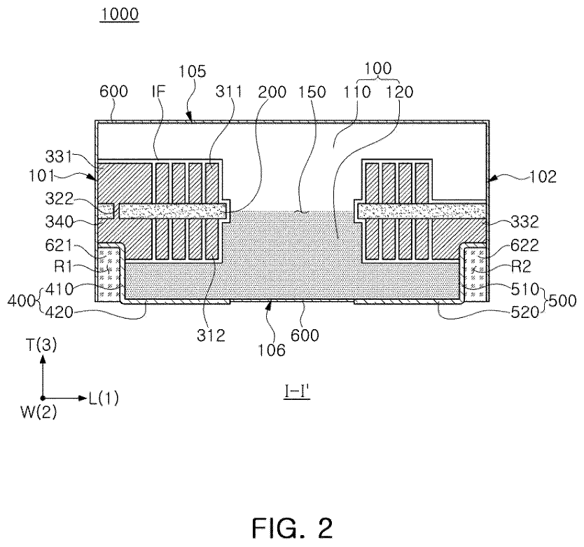

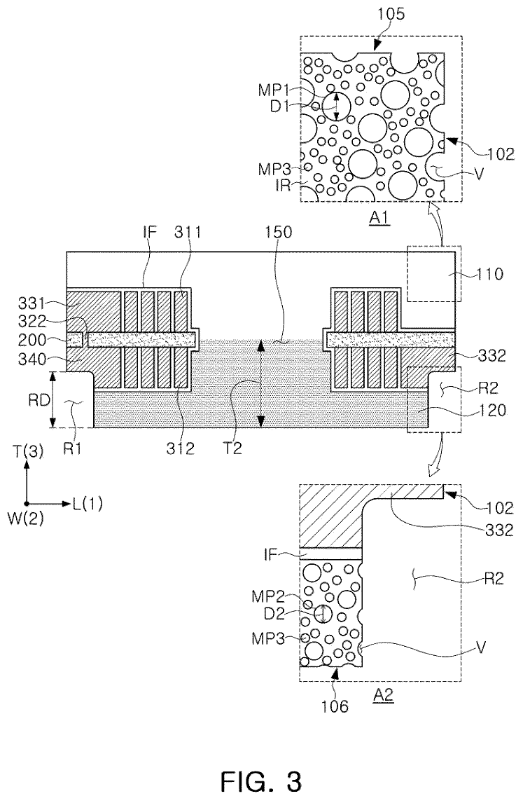

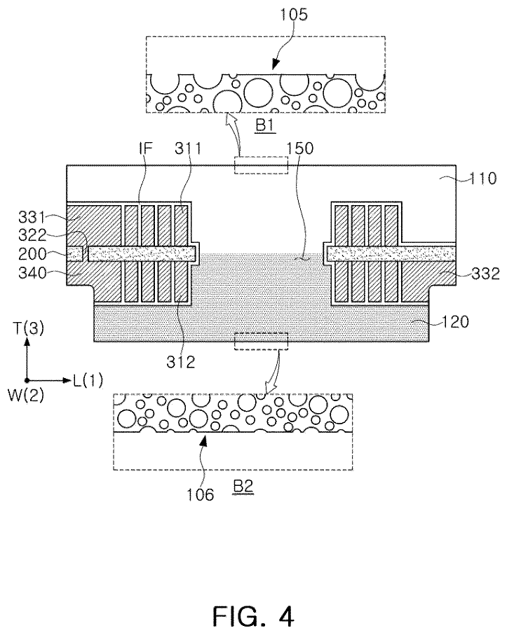

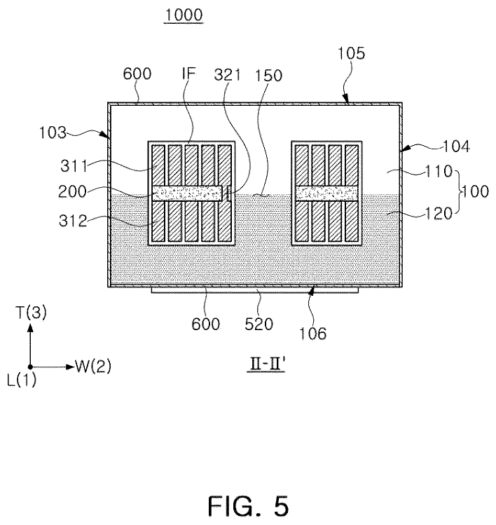

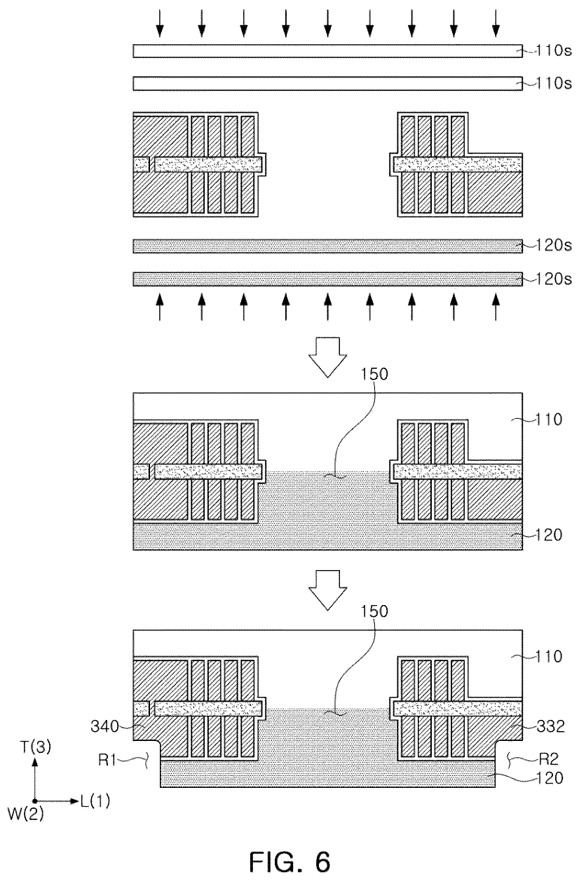

FIG. 1 is a perspective view schematically illustrating a coil component 1000 according to a first exemplary embodiment of the present disclosure; FIG. 2 is a view illustrating a cross-section taken along line I-I′ of FIG. 1; FIG. 3 is each enlarged view of regions A1 and A2; FIG. 4 is each enlarged view of regions B1 and B2; FIG. 5 is a view illustrating a cross-section taken along line II-II′ of FIG. 1; and FIG. 6 is a view briefly showing a manufacturing process of the coil component 1000 according to a first exemplary embodiment of the present disclosure.

Referring to FIGS. 1 through 6, the coil component 1000 according to a first exemplary embodiment of the present disclosure may include a body 100, a support member 200, a coil 300, and external electrodes 400 and 500, and may further include an insulating layer 600 covering the body 100.

The body 100 of the coil component 1000 according to this exemplary embodiment may be divided into a first region 110 and a second region 120, and a magnetic powder particles MP1 included in the first region 110 and a magnetic powder particles MP2 included in the second region 120 may have average diameters different from each other.

In detail, the first region 110 may be disposed on an upper part and the second region 120 may be disposed on a lower part in the third or T direction based on directions shown in FIG. 1. Here, the second region 120 may include the magnetic powder particles having a smaller average diameter than the magnetic powder particles included in the first region 110.

As such, each surface of recesses R1 and R2 may have lower surface-roughness by forming the recesses R1 and R2 described below in the second region 120 including the fine powder to improve a plating quality of the external electrode 400 or 500 disposed in the recess R1 or R2.

In addition, a lower surface of the body 100, that is, the sixth surface 106 may have the lower surface-roughness to thus improve an insulation printing quality when the insulating layer 600 is disposed on a mounting surface, thereby providing the insulating layer 600 made thinner.

Hereinafter, the description specifically describes the main components included in the coil component 1000 according to this exemplary embodiment.

The body 100 may form an exterior of the coil component 1000 according to this exemplary embodiment, and may embed the support member 200 and the coil 300.

The body 100 may generally have a hexahedral shape.

The body 100 may have a first surface and a second surface opposing each other in the length (L) direction or first direction, a third surface and a fourth surface opposing each other in the width (W) direction or second direction, and a fifth surface and the sixth surface opposing each other in the thickness (T) direction or third direction. Each of the first to fourth surfaces of the body 100 may correspond to a wall surface of the body 100 connecting the fifth and sixth surfaces of the body 100 to each other. Hereinafter, both end surfaces of the body 100 may indicate the first and second surfaces 101 and 102 of the body 100, both side surfaces of the body 100 may indicate the third and fourth surfaces 103 and 104 of the body 100, one surface of the body 100 may indicate the sixth surface 106 of the body 100, and the other surface of the body 100 may indicate the fifth surface 105 of the body 100.

For example, the body 100 may be formed for the coil component 1000 according to this exemplary embodiment including the external electrodes 400 and 500 described below to have: a length of 2.5 mm, a width of 2.0 mm, and a thickness of 1.0 mm; a length of 2.0 mm, a width of 1.2 mm, and a thickness of 0.65 mm; a length of 1.6 mm, a width of 0.8 mm, and a thickness of 0.8 mm; a length of 1.0 mm, a width of 0.5 mm, and a thickness of 0.8 mm; or a length of 0.8 mm, a width of 0.4 mm, and a thickness of 0.65 mm. However, the present disclosure is not limited thereto. Meanwhile, the above exemplary dimensions for the length, width, and thickness of the coil component 1000 may be dimensions that do not reflect process errors, and a range of the dimensions recognized to include the process errors may thus fall within that of the above-described exemplary dimensions.

The above length of the coil component 1000 may indicate the maximum value of respective dimensions of a plurality of line segments spaced apart from each other in the thickness (T) direction, and connecting two outermost boundary lines opposing each other in the length (L) direction of the coil component 1000 shown in the following image to be parallel to the length (L) direction, based on the optical microscope image or scanning electron microscope (SEM) image of a cross-section of the coil component 1000 in a length (L)-thickness (T) direction that is taken from its center in the width (W) direction. Other methods and/or tools appreciated by one of ordinary skill in the art, even if not described in the present disclosure, may also be used. Alternatively, the length of the coil component 1000 may indicate the minimum value of the respective dimensions of the plurality of line segments described above. Alternatively, the length of the coil component 1000 may indicate an arithmetic average value of at least three of the respective dimensions of the plurality of line segments described above. Here, the plurality of line segments parallel to the length (L) direction may be equally spaced from each other in the thickness (T) direction, and the scope of the present disclosure is not limited thereto.

The above thickness of the coil component 1000 may indicate the maximum value of respective dimensions of a plurality of line segments spaced apart from each other in the length (L) direction, and connecting two outermost boundary lines opposing each other in the thickness (T) direction of the coil component 1000 shown in the following image to be parallel to the thickness (T) direction, based on the optical microscope image or scanning electron microscope (SEM) image of the cross-section of the coil component 1000 in the length (L)-thickness (T) direction that is taken from its center in the width (W) direction. Other methods and/or tools appreciated by one of ordinary skill in the art, even if not described in the present disclosure, may also be used. Alternatively, the thickness of the coil component 1000 may indicate the minimum value of the respective dimensions of the plurality of line segments described above. Alternatively, the thickness of the coil component 1000 may indicate an arithmetic average value of at least three of the respective dimensions of the plurality of line segments described above. Here, the plurality of line segments parallel to the thickness (T) direction may be equally spaced from each other in the length (L) direction, and the scope of the present disclosure is not limited thereto.

The above width of the coil component 1000 may indicate the maximum value of respective dimensions of a plurality of line segments spaced apart from each other in the length (L) direction, and connecting two outermost boundary lines opposing each other in the width (W) direction of the coil component 1000 shown in the following image to be parallel to the width (W) direction, based on the optical microscope image or scanning electron microscope (SEM) image of a cross-section of the coil component 1000 in a length (L)-width (W) direction that is taken from its center in the thickness (T) direction. Other methods and/or tools appreciated by one of ordinary skill in the art, even if not described in the present disclosure, may also be used. Alternatively, the width of the coil component 1000 may indicate the minimum value of the respective dimensions of the plurality of line segments described above. Alternatively, the width of the coil component 1000 may indicate an arithmetic average value of at least three of the respective dimensions of the plurality of line segments described above. Here, the plurality of line segments parallel to the width (W) direction may be equally spaced from each other in the length (L) direction, and the scope of the present disclosure is not limited thereto.

Alternatively, each of the length, width and thickness of the coil component 1000 may be measured using a micrometer measurement method. The micrometer measurement method may be used by setting a zero point with a micrometer using a repeatability and reproducibility (Gage R&R), inserting the coil component 1000 according to this exemplary embodiment between tips of the micrometer, and turning a measurement lever of the micrometer. Meanwhile, when measuring the length of the coil component 1000 by using the micrometer measurement method, the length of the coil component 1000 may indicate a value measured once or an arithmetic average of values measured several times. This method may be equally applied to measure the width or thickness of the coil component 1000.

Referring to FIGS. 1 through 3, the body 100 of the coil component 1000 according to this exemplary embodiment may have the first and second recesses R1 and R2 each formed in an outer surface of the body, and the body 100 may include the magnetic powder particles.

In addition, the body 100 may be divided into the first region 110 and the second region 120. Here, an average diameter D2 of the magnetic powder particles MP2 included in the second region 120 may be smaller than an average diameter D1 of the magnetic powder particles MP1 included in the first region 110.

Meanwhile, the diameter of the magnetic powder particles in the specification may indicate a particle size distribution, such as D₅₀ or D₉₀. Therefore, different diameters of the magnetic powder particles may indicate that dimensions of the particle diameter distribution, such as D₅₀ or D₉₀, are different from each other. In this case, Dso may indicate a value disposed in the center when the values are arranged in order of a diameter size.

Meanwhile, the diameters D1 and D2 of the first and second magnetic powder particles MP1 and MP2 included in the body 100 may be measured on the cross-section of the body 100. In detail, the diameters of the first and second magnetic powder particles MP1 and MP2 may be measured using an image analysis program after capturing a plurality of cross-sections (e.g., five cross-sections) equally spaced from each other in the W direction by using the scanning electron microscope, based on the L-T cross-section of the coil component, passing through the center of the body 100. Other methods and/or tools appreciated by one of ordinary skill in the art, even if not described in the present disclosure, may also be used.

In this case, in an outer region of the body 100, the first and second magnetic powder particles MP1 and MP2 may be deformed or an oxide film on a surface of the magnetic powder particles may be destroyed by a compression process. Therefore, the diameter of the first and second magnetic powder particles MP1 and MP2 may be measured by excluding this region. For example, the measurement may exclude a region corresponding to a length within 5% or 10% of the surface of the body 100.

Meanwhile, each of the magnetic powder particles MP1 and MP2 may have a spherical or substantially spherical shape, and is not limited thereto. Therefore, the magnetic powder particles MP1 or MP2 may have an arbitrary shape that does not maintain the spherical shape. In this case, the above-mentioned diameter may be interpreted by being replaced with a feret diameter. A tool of image processing software may be used as a diameter average value calculation method to acquire size distribution through a particle size analysis for each region.

Referring to FIGS. 3 and 6, the body 100 may be formed by laminating and curing a plurality of magnetic sheets 110s and 120s each including the magnetic powder particles dispersed in insulating resin IR. Here, the first magnetic sheet 110s may include the first magnetic powder particle MP1 having a larger average particle diameter, and the second magnetic sheet 120s may include the second magnetic powder particle MP2 having a smaller average particle diameter than that of the first magnetic powder particle MP1.

The first magnetic sheets 110s may be laminated and cured to provide the first region 110 of the body 100, and the second magnetic sheets 120s may be laminated and cured to provide the second region 120 of the body 100.

Accordingly, an interface may be formed between the first region 110 and the second region 120.

Referring to FIGS. 2 and 3, the interface may be parallel to one surface of the body 100, that is, the sixth surface 106, and is not limited thereto. Here, being parallel may not be limited to a case of being completely parallel, and indicate being substantially parallel by including a process error.

Meanwhile, the interface between the first region 110 and the second region 120 may not be higher than the support member 200 described below based on directions shown in FIG. 2, and may be higher than a height RD of the recess R1 or R2. That is, the interface between the first region 110 and the second region 120 may be close to a plane. In this case, the interface may be disposed in a region between the support member 200 and a bottom surface of the recess R1 or R2 based on the third or T direction.

FIG. 3 shows an enlarged view A1 of the first region 110 and an enlarged view A2 of the second region 120.

The first region 110 may include the first magnetic powder particle MP1 having the larger average diameter D1 of the magnetic powder particle. The first region 110 may further include a third magnetic powder particle MP3 corresponding to an ultra-fine powder and the insulating resin IR in addition to the first magnetic powder particle MP1.

The first magnetic powder particle 110 may fall off in a process of processing the surface of the body 100, such as a process of dicing the coil components into individual components, and as a result, a void V may occur on an outer surface of the first region 110. The occurrence of the void V may cause a higher surface-roughness on the outer surface of the first region 110. The surface-roughness in the specification may indicate a center-line average roughness Ra, may be measured using an optical surface profiler or a surface-roughness measuring instrument, and may have an arithmetic average of values measured in the T-axis direction based on the L-T cross-section of the coil component, passing through the center of the surface. Other methods and/or tools appreciated by one of ordinary skill in the art, even if not described in the present disclosure, may also be used.

On the other hand, referring to the enlarged view A2 of the second region 120 in FIG. 3, the second region 120 may include the second magnetic powder particle MP2 having the average magnetic-powder diameter D2 smaller than that of the first magnetic powder particle MP1. The second region 120 may further include the third magnetic powder particle MP3 corresponding to the ultra-fine powder and the insulating resin IR in addition to the second magnetic powder particle MP2.

The second magnetic powder particle MP2 may fall off in the process of processing the surface of the body 100, such as the process of dicing the coil components into individual components. Here, the magnetic powder particle having a smaller particle diameter may be used for the second region 120, and the void V occurring when the magnetic powder particle falls off may thus also have a smaller size. As a result, the second region 120 may have the surface-roughness lower than that of the first region 110.

Referring to FIGS. 2 and 3, the regions where the external electrodes 400 and 500 described below are disposed may be the recesses R1 and R2 and the sixth surface 106. Here, the plating quality of the external electrodes 400 and 500 may be improved by disposing the recesses R1 and R2 and the sixth surface 106 in the second region 120 having the lower surface-roughness.

For example, the average diameter D1 of the first magnetic powder particle MP1 included in the first region 110 may be 25 μm or more and 30 μm or less, the average diameter D2 of the second magnetic powder particle MP2 included in the second region 120 may be 1 μm or more and 2 μm or less, and an average diameter of the third magnetic powder particle MP3 may be less than 1 μm. However, the present disclosure is not limited thereto.

Each of the first and second magnetic powder particles MP1 and MP2 may include one or more selected from the group consisting of iron (Fe), silicon (Si), chromium (Cr), cobalt (Co), molybdenum (Mo), aluminum (Al), niobium (Nb), copper (Cu), boron (B) and nickel (Ni). For example, each of the first and second magnetic powder particles MP1 and MP2 may be one or more of a pure iron powder, an Fe—Si—based alloy powder, an Fe—Si—Al-based alloy powder, an Fe—Ni-based alloy powder, an Fe—Ni—Mo-based alloy powder, an Fe—Ni—Mo—Cu-based alloy powder, an Fe—Co-based alloy powder, an Fe—Ni—Co-based alloy powder, an Fe—Cr-based alloy powder, an Fe—Cr—Si-based alloy powder, an Fe—Si—Cu—Nb-based alloy powder, an Fe—Ni—Cr-based alloy powder, an Fe—Cr—Al-based alloy powder, and an Fe—Si—B—Nb—Cu-based alloy powder.

Meanwhile, the insulating resin included in the body 100 may include epoxy, polyimide, liquid crystal polymer (LCP) or the like, or a mixture thereof, and is not limited thereto.

Referring to FIG. 1, the recesses R1 and R2 may be formed in the second region 120 of the body 100.

The recess R1 or R2 may be formed in an edge region of the sixth surface 106 of the body 100. In detail, the first recess R1 may be formed between the first surface 101 and sixth surface 106 of the body, and extend to the third surface 103 and fourth surface 104 of the body 100 in the second or W direction. In addition, the second recess R2 may be formed between the second surface 102 and sixth surface 106 of the body, and extend to the third surface 103 and fourth surface 104 of the body 100 in the second or W direction.

Meanwhile, none of the recesses R1 and R2 may extend to the fifth surface 105 of the body 100. That is, none of the recesses R1 and R2 may pass through the body 100 in the third or T direction of the body 100.

The recess R1 or R2 may be formed by performing pre-dicing on one surface of a coil bar along a virtual boundary line matching the second or W direction of each coil component among the virtual boundary lines for individualizing each coil component in a coil bar level, i.e., state of each coil component before individualized. A depth of the pre-dicing may be adjusted for a second lead portion 332 and a sub-lead portion 340 described below to be respectively exposed to the recesses R1 and R2.

An inner surface of the recess R1 and R2 may include an inner wall substantially parallel to the first or second surface 101 or 102 of the body 100, and a bottom surface connecting the inner wall and the first or second surface 101 or 102 of the body 100 to each other. However, the scope of the present disclosure is not limited thereto. For example, the inner surface of the first recess R1 may have a curved shape to connect the first and sixth surfaces 101 and 106 of the body 100 to each other on the L-T cross-section of the coil component. In this case, the inner surface of the first recess R1 may not be distinguished from the above-mentioned inner wall and bottom surface. Alternatively, the inner surface may have an irregular shape.

Meanwhile, the inner surfaces of the recesses R1 and R2 may also correspond to the surfaces of the body 100. However, for the convenience of understanding and explanation of the present disclosure, in the specification, the inner surfaces of the recesses R1 and R2 may be distinguished from the first to sixth surfaces 101, 102, 103, 104, 105, and 106), which are the surfaces of the body 100.

Referring to FIGS. 3, 4, and 6, the first and second recesses R1 and R2 may be disposed in the second region 120, and spaced apart from the first region 110. That is, during a dicing process of the first region 110 including a coarse powder, any magnetic powder particle having the larger average diameter may partially fall off from the surface of the body 100 to be diced to cause the occurrence of the void, which may result in the higher surface-roughness.

On the other hand, the second region 120 may be formed by laminating the second magnetic sheets 120s, that is, the fine powder sheets in each of which the magnetic powder particle has the smaller average diameter, and then performing the pre-dicing process for forming the recesses R1 and R2. Accordingly, the void occurring in the second region may have the smaller size, and the inner surface of the recess R1 or R2 may thus have the lower surface-roughness.

However, when the entire body 100 is made as the second region 120 including the fine powder sheet, the coil component may have lower permeability or inductance characteristic even though maintaining the lower surface-roughness. Therefore, it is required to maintain a proportion of the second region 120 in the entire body 100 not to be high.

Accordingly, the coil component 1000 according to this exemplary embodiment may have minimum degradation in the permeability or inductance characteristic by disposing the second region 120 to include a part where the recess R1 or R2 is formed, and a part where the insulating layer 600 is disposed between the first and second external electrodes 400 and 500 on the lower surface 106 of the body 100, and disposing the first region 110 including the coarse powder sheet in the other part.

The body 100 may have a core 150 passing through the support member 200 and the coil 300.

Referring to FIGS. 1 and 2, the core 150 may pass through the center of the support member 200, and the coil 300 may have a plurality of turns wound around the core 150.

The support member 200 may be disposed in the body 100. The support member 200 is a component supporting the coil 300. In detail, the support member 200 may support the first and second coil portions 311 and 312 disposed on both surfaces of the support member.

Meanwhile, the support member 200 may be excluded in some exemplary embodiments, such as a case where the coil 300 corresponds to a wound coil or has a coreless structure.

The support member 200 may be made of an insulating material including thermosetting insulating resin such as epoxy resin, thermoplastic insulating resin such as polyimide, or photosensitive insulating resin, or may be made of an insulating material having a reinforcement material such as a glass fiber or an inorganic filler impregnated in the insulating resin. For example, the support member 200 may be made of a material such as prepreg, an Ajinomoto Build-up Film (ABF), FR-4, bismaleimide triazine (BT) resin, a photo imagable dielectric (PID) or a copper clad laminate (CCL), and is not limited thereto.

The inorganic filler may use one or more materials selected from the group consisting of silica (or silicon dioxide, SiO₂), alumina (or aluminum oxide, Al₂O₃), silicon carbide (SiC), barium sulfate (BaSO₄), talc, clay, mica powder particles, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

Here, when made of the insulating material including the reinforcing material, the support member 200 may have more excellent rigidity. The support member 200 may be made of the insulating material including no glass fiber. In this case, an entire thickness of the support member 200 and the coil 300 (indicating sum of the respective dimensions of the coil 300 and the support member 200 in the third or T direction of FIG. 1) may be thinned, which is advantageous in reducing the thickness of the component. The support member 200 may be made of the insulating material including the photosensitive insulating resin. In this case, the number of processes for forming the coil 300 may be reduced, which is advantageous in reducing a production cost, and fine vias 321 and 322 may also be formed. For example, the support member 200 may have a thickness of 10 μm or more or 50 μm or less, and is not limited thereto.

The coil 300 may be embedded in the body 100 to express a characteristic of the coil component. For example, when the coil component 1000 of this exemplary embodiment is used as a power inductor, the coil 300 may store an electric field as a magnetic field to maintain an output voltage, thereby stabilizing power of the electronic device.

The coil 300 may include the first and second coil portions 311 and 312, the first via 321, and the first and second lead portions 331 and 332, and may further include the sub-lead portion 340 and the second via 322.

Referring to FIGS. 2 and 5, based on the directions shown in FIG. 2, the first coil portion 311 and the first lead portion 331 may be disposed on an upper surface of the support member 200 that faces the fifth surface 105 of the body 100, and the second coil portion 312, the second lead portion 332, and the sub-lead portion 340 may be disposed on a lower surface of the support member 200 that faces the sixth surface 106 of the body 100.

Referring to FIG. 2, the first coil portion 311 may be disposed on the upper surface of the support member 200 to have the plurality of turns wound around the core 150, and have the outermost turn extending to be in contact with the first lead portion 331. The first coil portion 311 may have a planar spiral shape, is not limited thereto, and may also have an angular shape.

The first lead portion 331 may be disposed on the upper surface of the support member 200 and exposed to the first surface 101 of the body 100, and may be covered by the insulating layer 600 described below.

The first lead portion 331 may be connected to the sub-lead portion 340 disposed on the lower surface of the support member 200 through the second via 322. The sub-lead portion 340 may be disposed on the lower surface of the support member 200 and spaced apart from the second coil portion 312.

The sub-lead portion 340 may be exposed to the first surface 101 of the body 100 and the inner surface of the first recess R1 to thus be connected to the first external electrode 400 described below. The sub-lead portion 340 may be disposed on only one surface of the body 100 asymmetrically in this exemplary embodiment, is not limited to, and may further include a sub-lead portion exposed to the second surface 102 of the body 100. When the sub-lead portion 340 is disposed only on one surface of the body 100 asymmetrically as in this exemplary embodiment, an effective volume of the body 100 may be increased to improve an inductance characteristic of the coil component.

The second coil portion 312 may be disposed on the lower surface of the support member 200 to have a plurality of turns wound around the core 150, and have the outermost turn extending to be in contact with the second lead portion 332. The second coil portion 312 may have a planar spiral shape, is not limited thereto, and may also have an angular shape.

The second lead portion 332 may be disposed on the lower surface of the support member 200, and exposed to the second surface 102 of the body 100 and the inner surface of the second recess R2 to thus be connected to the second external electrode 500 described below.

Referring to FIG. 5, the first via 321 may connect the first and second coil portions 311 and 312 disposed on both the surfaces of the support member 200 to each other. The first via 321 may pass through the support member 200 to connect the innermost turns of the first and second coil portions 311 and 312 to each other.

Accordingly, a signal input to the first external electrode 400 may be output to the second external electrode 500 through the sub-lead portion 340, the second via 322, the first coil portion 311, the first via 321, the second coil portion 312, and the second lead portion 332. Through this structure, the respective components of the coil 300 may entirely function as one coil connected between the first and second external electrodes 400 and 500.

At least one of the first and second coil portions 311 and 312, the first and second vias 321 and 322, the first and second lead portions 331 and 332, and the sub-lead portion 340 may include at least one conductive layer. For example, the first coil portion 311, the first lead portion 331, and the first via 321 may be plated on the upper surface of the support member 200. In this case, each of the first coil portion 311, the first lead portion 331, and the first via 321 may include a first conductive layer formed by electroless plating or the like, and a second conductive layer disposed on the first conductive layer.

The first conductive layer may be a seed layer for plating the second conductive layer on the support member 200, and the second conductive layer may be an electroplating layer. Here, the electroplating layer may have a single-layer or multi-layer structure. The electroplating layer having the multi-layer structure may be a conformal film in which another electroplating layer covers one electroplating layer, or may be a layer in which another electroplating layer is laminated on only one surface of one electroplating layer. The seed layer of the first coil portion 311 and the seed layer of the first lead portion 331 may be integrally formed to thus have no boundary therebetween, and are not limited thereto. The electroplating layer of the first coil portion 311 and the electroplating layer of the first lead portion 331 may be integrally formed to thus have no boundary therebetween, and are not limited thereto.

Each of the first and second coil portions 311 and 312, the first and second vias 321 and 322, the first and second lead portions 331 and 332, and the sub-lead portion 340 may be made of a conductive material such as copper (Cu), aluminum (Al), silver (Ag), tin (Sn), gold (Au), nickel (Ni), lead (Pb), titanium (Ti), or an alloy thereof, and is not limited thereto.

Referring to FIGS. 2 and 5, an insulating film IF may insulate the coil portions 311 and 312, the lead portions 331 and 332, and the sub-lead portion 340 from the body 100. The insulating film IF may include, for example, parylene, and is not limited thereto. The insulating film IF may be formed by vapor deposition or the like, is not limited thereto, and may be formed by laminating insulating films on both the surfaces of the support member 200. Meanwhile, the insulating film IF may include a portion of the plating resist used in forming the coil 300 by electroplating, and is not limited thereto.

Referring to FIG. 2, the first and second external electrodes 400 and 500 may be disposed on one surface 106 of the body 100 to be spaced apart from each other, and respectively extend to the first and second recesses R1 and R2 to be connected to the sub-lead portion 340 and the second lead portion 332.

In detail, the first external electrode 400 may include a first connection portion 410 disposed in the first recess R1 and in contact with the sub-lead portion 340 exposed to the inner surface of the first recess R1, and a first pad portion 420 extending from the first connection portion 410 to the sixth surface 106 of the body 100.

In addition, the second external electrode 500 may include a second connection portion 510 disposed in the second recess R2 and in contact with the second lead portion 332 exposed to the inner surface of the second recess R2, and a second pad portion 520 extending from the second connection portion 510 to the sixth surface 106 of the body 100.

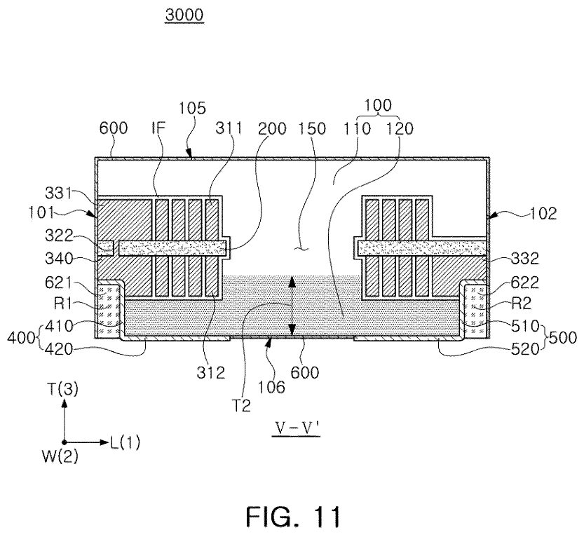

The first pad portion 420 and the second pad portion 520 may be disposed on the sixth surface 106 of the body 100 to be spaced apart from each other. In addition, the first and second pad portions 420 and 520 may protrude beyond the insulating layer 600 described below, and are not limited thereto. When the coil component 1000 is mounted on the board as shown in FIG. 11, the pad portion protruding as in this exemplary embodiment may have a wider contact area with a connection member 12 for the coil component 1000 to have an improved bonding strength and an increased stand-off height (SOH) from a printed circuit board (PCB) to thus have a lower risk of a short circuit.

The connection portion 410 or 510 may be disposed in the center of the inner surface of the recess R1 or R2 in the width W direction. The pad portion 420 or 520 may be disposed in the center of the sixth surface of body 100 in the width W direction. That is, none of the connection portions 410 and 510 and the pad portions 420 and 520 may extend to the third surface 103 or fourth surface 104 of the body 100.

Meanwhile, FIGS. 1 and 5 show that the connection portion 410 or 510 and the pad portion 420 or 520 have the same width in the W width direction, which is only an example, and the scope of the present disclosure is not limited thereto. For example, the pad portion 420 or 520 may have a greater width in the W width direction than that of the connection portion 410 or 510 in the W width direction.

Referring to FIG. 2, the external electrode 400 or 500 may be disposed along the inner surface of the recess R1 or R2 and the sixth surface 106 of the body 100. That is, the external electrode 400 or 500 may have a shape of a conformal film disposed on the inner surface of recess R1 or R2 and the sixth surface 106 of the body 100. The external electrode 400 or 500 may be integrally disposed on the inner surface of the recess R1 or R2 and the sixth surface 106 of the body 100. In this case, the external electrode 400 or 500 may be formed by a thin film process such as a sputtering process or a plating process.

Referring to FIGS. 1 through 3, the external electrode 400 or 500 may be in contact with the second region 120, and spaced apart from the first region 110. The plating quality of the external electrode 400 or 500 may be improved by disposing the external electrode 400 or 500 in the second region 120 having the lower surface-roughness by including the second magnetic powder particle MP2 corresponding to the fine powder.

The external electrode 400 or 500 may be made of a conductive material such as copper (Cu), aluminum (Al), silver (Ag), tin (Sn), gold (Au), nickel (Ni), lead (Pb), chromium (Cr), titanium (Ti), or an alloy thereof, and is not limited thereto.

The external electrode 400 or 500 may have a multi-layer structure. For example, a first layer in which the external electrode 400 or 500 is connected to the coil 300 may be a conductive resin layer including a conductive powder including at least one of copper (Cu) and silver (Ag) and the insulating resin, or may be a copper (Cu) plating layer. In addition, a second layer may have a double layer structure of a nickel (Ni) plating layer and a tin (Sn) plating layer.

The first layer may be made by the electroplating, the vapor deposition such as the sputtering, or by applying and curing a conductive paste including the conductive powder such as copper (Cu) and/or silver (Ag), and the second layer may be made by the electroplating.

The coil component 1000 according to this exemplary embodiment may further include the insulating layer 600 covering the outer surface of the body 100, and exposing the pad portion 420 or 520 disposed on the sixth surface 106, that is, the mounting surface.

Referring to FIGS. 4 and 5, the insulating layer 600 covering the body 100 may be in contact with the second region 120, on the sixth surface 106 of the body 100. The insulating layer 600 may be in contact with the first and second regions 110 and 120, and the surface-roughness of the second region 120 in contact with the insulating layer 600 may be lower than the surface-roughness of the first region 110 in contact with the insulating layer 600. For example, the fifth surface 105 shown in the enlarged view B1 may correspond to the first region 110, may be a region in which the insulating layer 600 is disposed, and have the higher surface-roughness. On the other hand, the sixth surface 106 shown in enlarged view B2 may correspond to the second region 120, may be a region in which the insulating layer 600 is disposed, and have the lower surface-roughness.

In addition, the surface-roughness of the second region 120 in contact with each of the first and second external electrodes 400 and 500 may be lower than the surface-roughness of the first region 110 in contact with the insulating layer 600.

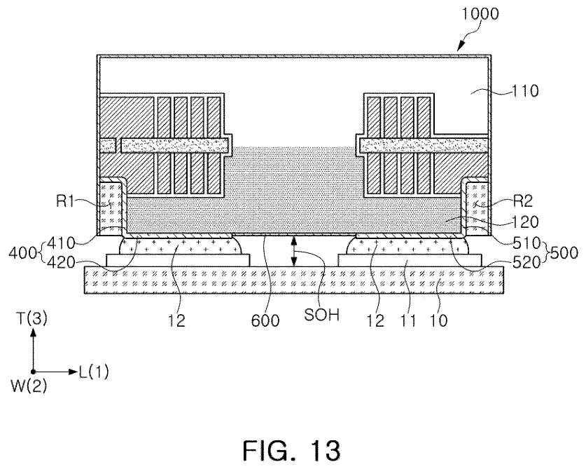

FIG. 13 is a view illustrating that the coil component 1000 according to the exemplary embodiment of the present disclosure is mounted on the printed circuit board (PCB). Referring to FIGS. 4 and 13, the insulating layer 600 may be disposed in the first region 110 and second region 120 of the body 100, and the insulating layer 600 may be easily disposed and the insulation printing quality may be improved in the second region 120 having the lower surface-roughness.

Accordingly, the coil component may have secured insulation reliability even though the insulating layer 600 is made thin in the second region 120. In addition, when mounted on the board as shown in FIG. 11, the coil component 1000 may have the increased stand-off height (SOH) from the printed circuit board (PCB) to thus have the lower risk of the short circuit as well as lower interference with a magnetic flux formed around the coil 300.

The insulating layer 600 may be formed, for example, by coating and curing an insulating material including the insulating resin on the surface of the body 100. In this case, the insulating layer 600 may include at least one of thermoplastic resin such as polystyrene-based resin, vinyl acetate-based resin, polyester-based resin, polyethylene-based resin, polypropylene-based resin, polyamide-based resin, rubber-based resin, acrylic-based resin, thermosetting insulating resin such as phenol-based resin, epoxy-based resin, urethane-based resin, melamine-based resin, and alkyd-based resin, and the photosensitive insulating resin.

Meanwhile, referring to FIG. 2, the coil component 1000 according to this exemplary embodiment may further include filling portions 621 and 622 respectively disposed between the recesses R1 and R2 and the insulating layer 600.

The filling portion 621 or 622 may improve the exterior of the coil component 1000 by filling the edge region depressed due to formation of the recess R1 or R2, and also improve the printing quality of the insulating layer 600.

The first and second filling portions 621 and 622 in this exemplary embodiment may at least partially cover the first and second connection portions 410 and 510, respectively.

The filling portion 621 or 622 may have one surface substantially coplanar with some of the first to fourth surfaces 101, 102, 103, and 104 of the body 100. That is, the first filling portion 621 may be substantially coplanar with the first, third, and fourth surfaces 101, 103, and 104 of the body 100, and the second filling portion 622 may be substantially coplanar with the second, third, and fourth surfaces 102, 103, and 104 of the body 100. Here, substantially coplanar may indicate that two parts may share substantially the same plane, including the process error.

The filling portion 621 or 622 may be formed in the recess R1 or R2 where the connection portion 410 or 510 is formed using a printing method, the vapor deposition method, a spray coating method, a film laminating method, or the like, and is not limited thereto. The filling portion 621 or 622 may include thermoplastic resin such as polystyrene-based resin, vinyl acetate-based resin, polyester-based resin, polyethylene-based resin, polypropylene-based resin, polyamide-based resin, rubber-based resin, acrylic-based resin, thermosetting such as phenol-based resin, epoxy-based resin, urethane-based resin, melamine-based resin, and alkyd-based resin, and the photosensitive resin, parylene, silicon dioxide (SiOx), or silicon nitride (SiNx).

FIG. 6 is a view briefly showing a manufacturing process of the coil component 1000 according to a first exemplary embodiment of the present disclosure.

Referring to FIG. 6, the body 100 may be formed by laminating and curing the plurality of magnetic sheets 110s and 120s on the upper and lower surfaces of the support member 200 on which the coil 300 is disposed.

The magnetic sheet may include the magnetic powder particles and the insulating resin. In this exemplary embodiment, the first and second magnetic sheets 110s and 120s in which the magnetic powder particles have the different average diameters may be divided into the upper and lower parts to be laminated and cured. Through this process, the body 100 may be divided into the first region 110 including the first magnetic powder particle MP1 corresponding to the coarse powder, and the second region 120 including the second magnetic powder particle MP2 corresponding to the fine powder.

When formed by the pre-dicing process after the body 100 is formed, the recesses R1 and R2 may be formed in the second region 120 to thus have the lower surface-roughness, thereby improving the plating quality of the external electrodes 400 and 500.

### Second Exemplary Embodiment

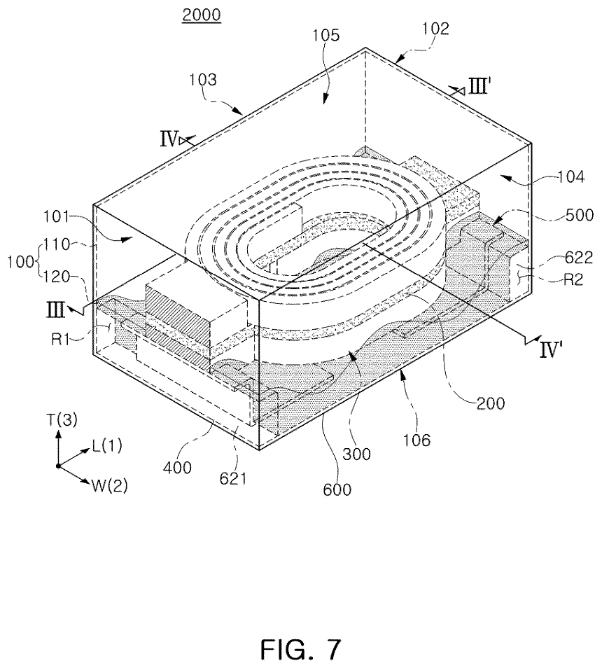

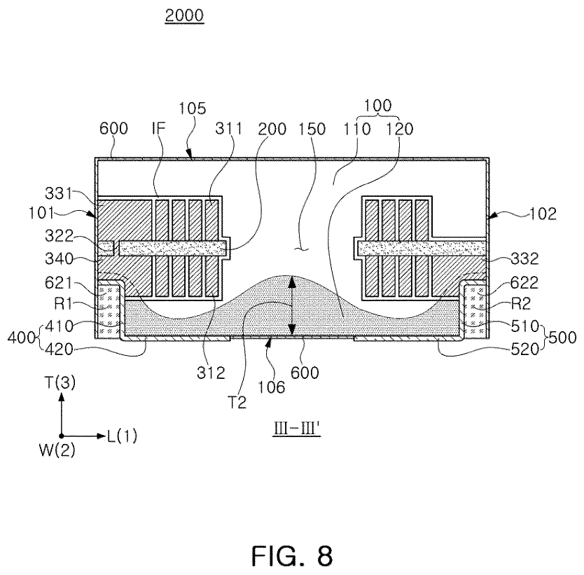

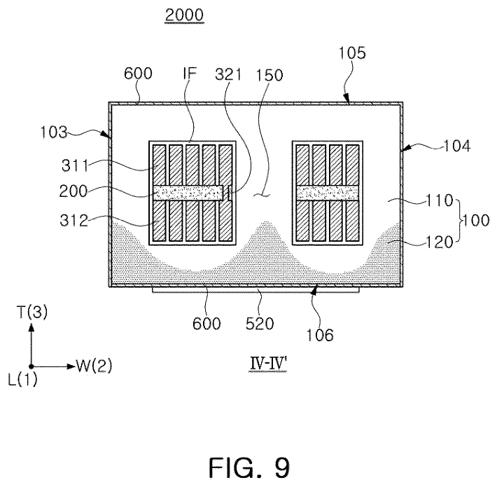

FIG. 7 is a perspective view schematically illustrating a coil component 2000 according to a second exemplary embodiment of the present disclosure; FIG. 8 is a view illustrating a cross-section taken along line III-III′ of FIG. 7, and is a view corresponding to FIG. 2; and FIG. 9 is a view illustrating a cross-section taken along line IV-IV′ of FIG. 7, and is a view corresponding to FIG. 5.

Referring to FIGS. 7 through 9, disposition of the second region 120 and a shape of the interface between the first region 110 and the second region 120 are different when compared to those in the first exemplary embodiment.

Therefore, in describing this exemplary embodiment, the disposition of the second region 120 and the shape of the interface between the first region 110 and the second region 120, which are different from those in the first exemplary embodiment of the present disclosure, are only described, and the descriptions of the other configurations in the first exemplary embodiment of the present disclosure may be equally applied to descriptions of those in this exemplary embodiment.

Referring to FIGS. 7 through 9, the interface between the first region 110 and the second region 120 may be curved toward the core 150.

Referring to FIG. 8, a thickness T2 of the second region 120 may be greater in a region between the core 150 and the sixth surface 106 of the body 100 than in a region between the coil 300 and the sixth surface 106 of the body 100. The thickness T2 may be measured by an optical microscope image or a scanning electron microscope (SEM). Other methods and/or tools appreciated by one of ordinary skill in the art, even if not described in the present disclosure, may also be used.

In the coil component 2000 according to this exemplary embodiment, a proportion of the second region 120 in the body 100 may be smaller than that in the first exemplary embodiment. The reason why the proportion of the second region 120 is reduced is that the second region 120 including the fine powder may have the lower permeability than the first region 110.

This exemplary embodiment may be implemented when fluidity of the magnetic sheet forming the body 100 is sufficiently secured. Here, the second region 120 may further occupy a portion where the coil 300 is not disposed, and the interface may thus be curved.

Through this structure, while reducing the proportion of the second region 120, a region of the lower part, where the recesses R1 and R2 and the insulating layer 600 are to be disposed, may be formed as the second region 120 including the fine powder, thereby improving the plating quality of the external electrode 400 or 500 and the printing quality of the insulating layer 600.

### Third Exemplary Embodiment

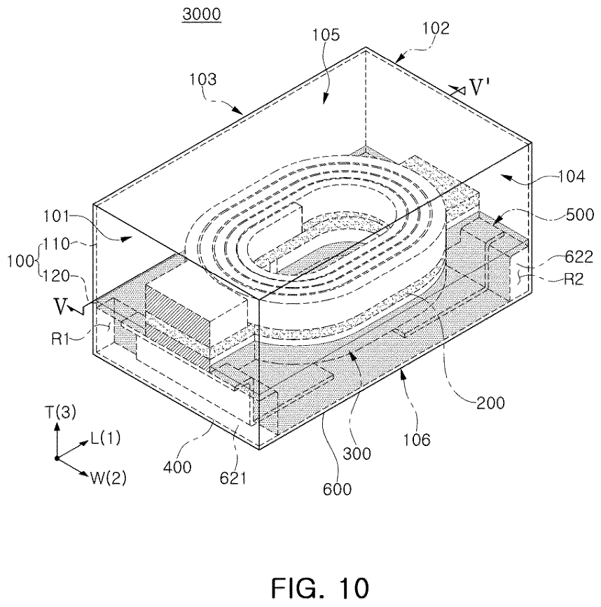

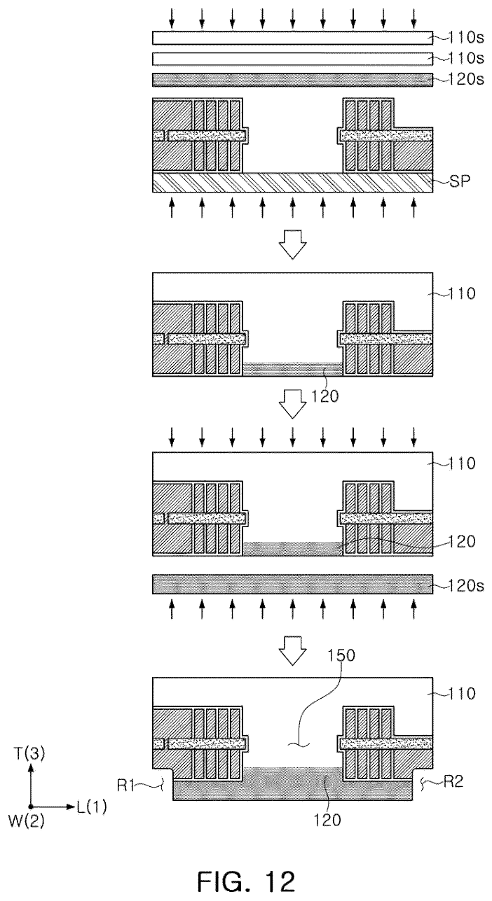

FIG. 10 is a perspective view schematically illustrating a coil component 3000 according to a third exemplary embodiment of the present disclosure; FIG. 11 is a view illustrating a cross-section taken along line V-V′ of FIG. 10, and is a view corresponding to FIG. 2; and FIG. 12 is a view briefly showing a manufacturing process of the coil component 3000 according to a third exemplary embodiment of the present disclosure.

Referring to FIGS. 10 and 11, the proportion of the second region 120 in the body 100 and the thickness (or a dimension in the T direction) of the second region 120 are different when compared to those in the first exemplary embodiment.

Therefore, in describing this exemplary embodiment, the proportion of the second region 120 in the body 100 and the thickness (or a T-direction dimension) of the second region 120, which are different from those in the first exemplary embodiment of the present disclosure, are only described, and the descriptions of the other configurations in the first exemplary embodiment of the present disclosure may be equally applied to descriptions of those in this exemplary embodiment.

Referring to FIGS. 10 and 11, in the coil component 3000 according to this exemplary embodiment, the second region 120 may have a smaller proportion than that in the first exemplary embodiment, and have the smaller thickness T2, that is, a lower height of the interface between the first region 110 and the second region 120.

In this exemplary embodiment, the second region 120 may have a lower level than that of the support member 200, and may be higher than the maximum height (or T-direction dimension) of the recess R1 or R2.

In this exemplary embodiment, a cross-sectional area of the first region 110 may be wider than a cross-sectional area of the second region 120 on a W-T cross-section of the coil component that is assumed to pass through the center of the coil 300. The cross-sectional areas may be measured by an optical microscope image or a scanning electron microscope (SEM). Other methods and/or tools appreciated by one of ordinary skill in the art, even if not described in the present disclosure, may also be used.

In this exemplary embodiment, the proportion of the second region 120 may be easily controlled even though the fluidity of the magnetic sheet forming the body 100 is not sufficiently secured.

That is, referring to FIG. 12, the proportion and level of the second region 120 may be easily controlled by processes of laminating and curing the first and second magnetic sheets 110s and 120s while the support member 200, in which the coil 300 disposed, is disposed on a support plate SP, and then laminating and curing the additional second magnetic sheet 120s on the lower part.

It is possible to control the formation of the recess R1 or R2 for the pre-dicing process to be performed on the second region 120, thereby improving the plating quality of the external electrode 400 or 500 and the printing quality of the insulating layer 600 while minimizing the proportion of the second region 120.

### Mounting Effect

FIG. 13 is a view illustrating that the coil component 1000 according to a first exemplary embodiment of the present disclosure is mounted on a printed circuit board (PCB). The other configurations of the coil component 1000 other than the proportion and shape of the second region 120 are the same as those of the coil components 2000 and 3000 in the second and third exemplary embodiments, and these configurations may thus be equally applied thereto.

The first and second external electrodes 400 and 500 may electrically connect the coil component 1000 to a printed circuit board 10 or the like when the coil component 1000 according to this exemplary embodiment is mounted on the printed circuit board 10 or the like. For example, the first and second external electrodes 400 and 500 disposed on the sixth surface 106 of the body 100 while being spaced apart from each other and a mounting pad 11 of the printed circuit board 10 may be electrically connected to each other by the connection member 12 such as solder.

In this exemplary embodiment, the insulating layer 600 disposed on the sixth surface 106 of the body 100 may be disposed in the second region 120 to improve the insulation printing quality, and the insulating layer 600 may thus be made thinner. As a result, the coil component may have the increased stand-off height (SOH) from the printed circuit board 10 when mounted thereon.

Further, as the insulating layer 600 disposed on the lower surface made thinner, the pad portion 420 or 520 of the external electrode 400 or 500 may protrude to have the increased contact area with the connection member 12, thereby improving the bonding strength of the coil component.

As set forth above, according to an aspect of the present disclosure, the fine powder sheet may be disposed in the region in which the recess is formed to implement the lower surface electrode in the body to thus secure the lower surface-roughness, thereby improving the plating quality of the external electrode disposed in the recess.

According to another aspect of the present disclosure, the insulation printing quality of the lower insulating layer disposed between the two lower surface electrodes on the body may be improved to thus implement the insulating layer made thinner.

According to another aspect of the present disclosure, the plating quality of the external electrode and the printing quality of the lower insulating layer may be improved while minimizing the side effect such as the lower permeability.

While the exemplary embodiments have been shown and described above, it will be apparent to those skilled in the art that modifications and variations could be made without departing from the scope of the present disclosure as defined by the appended claims.

What is claimed is:

1. A coil component comprising:
a body having first and second recesses on outer surfaces, and including magnetic powder particles;
a support member disposed in the body;
a coil disposed on the support member; and
first and second external electrodes disposed on one surface of the body and respectively extending to the first and second recesses to be connected to the coil,
wherein the body is divided into a first region and a second region, an average diameter of the magnetic powder particles included in the second region is smaller than an average diameter of the magnetic powder particles included in the first region, and
the first and second recesses are disposed in the second region.

2. The coil component of claim 1, wherein the first and second recesses are spaced apart from the first region.

3. The coil component of claim 1, wherein the first and second external electrodes are in contact with the second region.

4. The coil component of claim 3, wherein the first and second external electrodes are spaced apart from the first region.

5. The coil component of claim 1, wherein an interface is disposed between the first region and the second region.

6. The coil component of claim 5, wherein the interface is parallel to the one surface of the body.

7. The coil component of claim 5, wherein the body includes a core passing through the coil and the support member, and
the interface is curved toward the core.

8. The coil component of claim 7, wherein a thickness of the second region is greater in a region between the core and the one surface of the body than in a region between the coil and the one surface of the body.

9. The coil component of claim 1, wherein the body has a first surface and a second surface opposing each other in a first direction, a third surface and a fourth surface opposing each other in a second direction perpendicular to the first direction, and a fifth surface and a sixth surface opposing each other in a third direction perpendicular to each of the first and second directions, and
the first and second recesses are disposed between the first surface and the sixth surface, and between the second surface and the sixth surface, respectively, and extend to the third surface and the fourth surface in the second direction.

10. The coil component of claim 9, wherein the first region has a cross-sectional area perpendicular to the first direction and passing through a center of the coil and is wider than that of the second region.

11. The coil component of claim 9, wherein the first external electrode includes a first connection portion disposed in the first recess, and a first pad portion extending from the first connection portion to the sixth surface, and
the second external electrode includes a second connection portion disposed in the second recess, and a second pad portion extending from the second connection portion to the sixth surface.

12. The coil component of claim 11, further comprising an insulating layer covering the body,
wherein the insulating layer exposes the first and second pad portions disposed on the sixth surface.

13. The coil component of claim 12, wherein the insulating layer is in contact with the second region on the sixth surface.

14. The coil component of claim 12, wherein surface-roughness of the second region in contact with the insulating layer is lower than surface-roughness of the first region in contact with the insulating layer.

15. The coil component of claim 12, wherein surface-roughness of the second region in contact with each of the first and second external electrodes is lower than surface-roughness of the first region in contact with the insulating layer.

16. The coil component of claim 12, wherein the first and second pad portions protrude beyond the insulating layer.

17. The coil component of claim 12, further comprising first and second filling portions respectively disposed between the first and second recesses and the insulating layer,
wherein the first and second filling portions at least partially cover the first and second connection portions, respectively.

18. The coil component of claim 9, wherein the coil includes first and second coil portions respectively disposed on one surface and the other surface of the support member, a first via connecting the first and second coil portions to each other, a first lead portion extending from the first coil portion to the first surface, and a second lead portion extending from the second coil portion to the second surface, and
the second lead portion at least partially extends to the second recess.

19. The coil component of claim 18, wherein the coil further includes a sub-lead portion disposed on the other surface of the support member while being spaced apart from the second coil portion and at least partially extending to the first recess, and a second via connecting the first lead portion and the sub-lead portion to each other,
the first external electrode is connected to the sub-lead portion, and
the second external electrode is connected to the second lead portion.

20. A coil component comprising:
a body having first and second recesses on outer surfaces, and including magnetic powder particles;
a support member disposed in the body;
a coil disposed on the support member; and
first and second external electrodes disposed on one surface of the body and respectively extending to the first and second recesses to be connected to the coil,
wherein the body is divided into a first region and a second region, a thickness of the second region is greater in a middle portion of the body than in a region between the coil and the one surface of the body, and
the first and second recesses are disposed in the second region.

21. The coil component of claim 20, wherein an average diameter of the magnetic powder particles included in the second region is smaller than an average diameter of the magnetic powder particles included in the first region.

22. The coil component of claim 20, wherein the first and second external electrodes directly contact the second region and do not directly contact the first region.

23. The coil component of claim 20, further comprising an insulating layer covering the body,
wherein the insulating layer is in contact with the second region and disposed between the first and second external electrodes.
